(19) United States
(12) Patent Application Publication
(10) Pub. No.: US 2008/0127473 A1
(43) Pub. Date: Jun. 5, 2008

(54) Tool kit for removing decorative plates and trims of vehicles

(76) Inventor: Min-Chi Yu, Taichung City (TW)

Correspondence Address: BIRCH STEWART KOLASCH & BIRCH, PO BOX 747, FALLS CHURCH, VA, 22040-0747, US

(21) Appl. No.: 11/606,925

(22) Filed: Dec. 1, 2006

(51) Int. Cl. B23P 19/04; B65D 85/00

(52) U.S. Cl. 29/267; 206/372

(57) ABSTRACT

A tool kit for removing decorative plates and trims of vehicles includes a box holding a plurality of tools of different specifications. The tools are made from hard plastics and formed respectively like a plate. The tools have a first end which may be formed in a shape of a curve, sharp end, wedge or shield, and is gradually thinning from the middle portion towards one end to become a first prying portion. The tools have a second end which also may be formed in the shape of a sharp end, square or wedge, and is bent toward one side to become a second prying portion. A user could grasp each of the tools and insert the first or the second prying portion into a slip gap on the edge of various decorative plates and trims of vehicles to remove the decorative plates and trims without damaging the surfaces of the vehicles.

### FIELD OF THE INVENTION

The present invention relates to a tool kit for removing decorative plates and trims of vehicles and particularly to a tool kit that does not damage the decorative plates and trims or surrounding surfaces of vehicles.

### BACKGROUND OF THE INVENTION

The conventional approach for vehicle repairing technicians to pry the decorative plates and trims attached to the surface of vehicles is accomplished through a thin-tipped screw driver that has a thin metallic tip as shown in FIG. 1. As the decorative plates or trims are generally directly wedged in the lamp sockets or front and rear bumpers of the vehicles to provide a smooth appearance to match the vehicle surface, or wedged in the inner and outer sides of car doors to form a secured fastening without dropping, to remove the decorative plates or trims the conventional approach is first wedging the tip of a thin-tipped screw driver in a slit gap between the edge of the decorative plates (trims) and the vehicle surface, then exerting a force slowly to pry the decorative plates (trims) for removal. During this process the metallic thin-tipped screw driver often has to lean against the vehicle surface and results in damaging of the coating paint or wood panel on the vehicle surface. Moreover, the decorative plates and trims are mounted onto different locations of the vehicles, the prying operation often has to be done in a constrained space. In addition, prying operation for all the decorative plates and trims cannot be accomplished by using merely one type of thin-tipped screw driver.

### SUMMARY OF THE INVENTION

In view of the problems occurred to the conventional techniques mentioned above, the primary object of the present invention is to provide a tool kit for removing decorative plates and trims of vehicles. It includes a box which holds a plurality of tools of different specifications. The tools are made from hard plastics and formed respectively like a plate. Each of the tools has a first end formed in a desired shape such as a curve, sharp end, wedge or shield, and is gradually thinning from the middle portion towards one end become a first prying portion. It has a second end which also may be formed in the shape of a sharp end, square or wedge, and also is gradually thinning outwards another end or forming a bend portion on one side to become a second prying portion on a second end. Therefore according to the profiles and mounting positions of the decorative plates or trims at various vehicle locations, a desired tool may be selected and grasped to wedge the first or second prying portion in a slit gap formed on the edge of the decorative plates or trims to lift and remove the decorative plates or trims without damaging the decorative plates or trims and the surrounding surface. The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional technique for prying a decorative plate or trim through a thin-tipped screw driver.

FIG. 2 is a perspective view of an embodiment of the present invention.

FIG. 3 is a perspective view of an embodiment of a first type tool of the present invention.

FIG. 4 is a perspective view of an embodiment of a second type tool of the present invention.

FIG. 5 is a perspective view of an embodiment of a third type tool of the present invention.

FIG. 6 is a perspective view of an embodiment of a fourth type tool of the present invention.

FIG. 7 is a perspective view of an embodiment of a fifth type tool of the present invention.

FIG. 8 is a perspective view of an embodiment of a sixth type tool of the present invention.

FIG. 9 is a schematic view of the present invention to pry a plastic case of the vehicle rear trunk through the first and second types of tools.

FIG. 10 is a schematic view of the present invention to pry a trim on the vehicle roof panel though the fifth type tool.

FIG. 11 is a schematic view of the present invention to pry an air bag on an inner side of a car door through the second type tool.

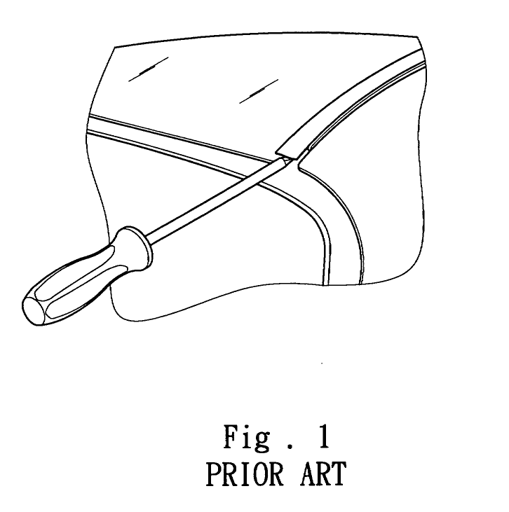

### DETAILED DESCRIPTION OF THE PREFERRED EMBODIMENTS

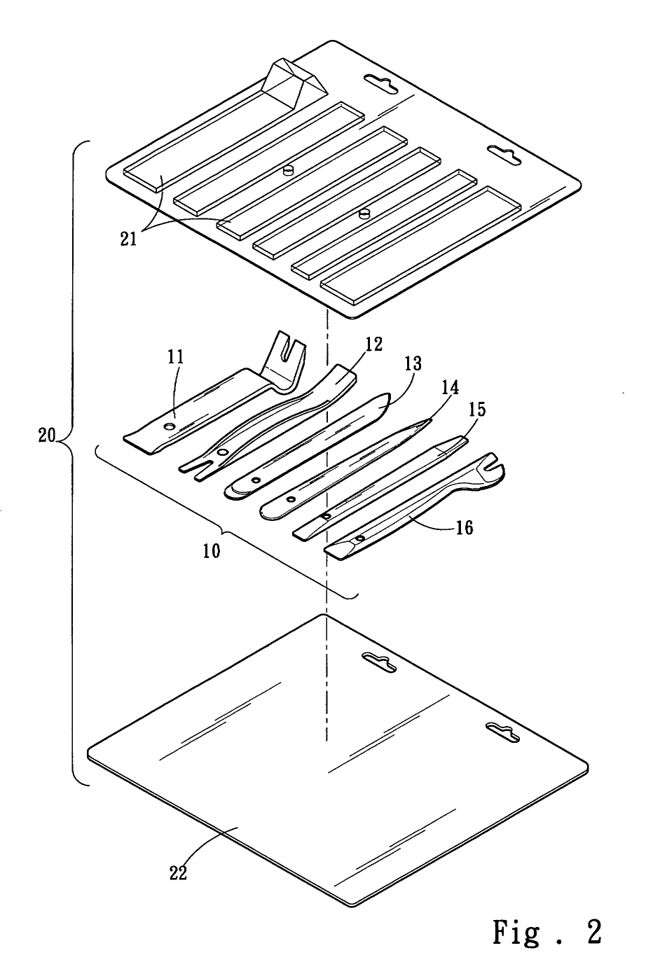

Please referring to FIG. 2, the tool kit for removing decorative plates and trims of vehicles according to the invention includes a box 20 made from transparent plastics that holds a plurality of tools 10 of different specifications and profiles. The tools 10 includes a first type tool 11, a second type tool 12, a third type tool 13, a fourth type tool 14, a fifth type tool 15, and a sixth type tool 16. Each of the tools 10 is made from hard plastics and formed like a plate. The first type tool 11, second type tool 12, third type tool 13, fourth type tool 14, fifth type tool 15 and sixth type tool 16 are held in anchor troughs 21 of various sizes formed in the box 20. The box 20 is sealed through a back panel 22 on the rear side to anchor the tools.

Refer to FIG. 3 for the first type tool 11. It is formed at a selected thickness, and includes a first end 111 and a second end 112. The first end 111 has one end with the left side and the right side relatively extended sidewards in a shield-shape to become a first prying portion 113. The first prying portion 113 is extended from one surface of the tool body of the first type tool 11 towards another surface in an inclined manner to become thinner. The second end 112 is extended from the first type tool 11 towards another side and bent at a desired angle like a hook. The second end 112 has another end inclining from one surface towards another surface to become thinner to form a second prying portion 114. The second prying portion 114 has a first notch 115 in the center.

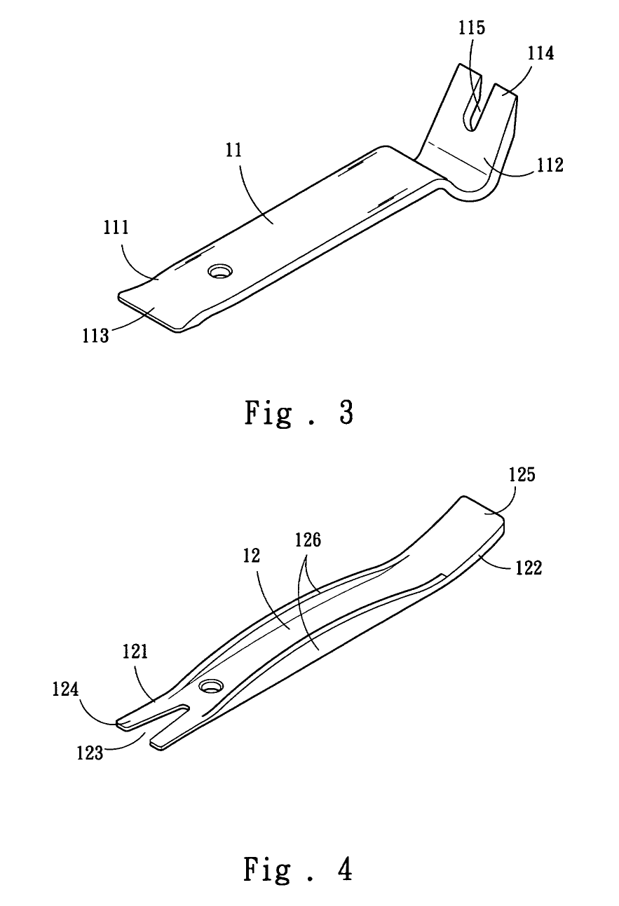

Refer to FIG. 4 for the second type tool 12. It includes a first end 121 and a second end 122. The first end 121 is extended from one surface of the body of the second type tool 12 towards one end in an inclined manner to become thinner, and has a second notch 123 in the center to become a fork-like first prying portion 124. The second end 122 is extended from one surface of the second type tool 12 towards another surface in an inclined manner at a selected angle to form a second prying portion 125. The second type tool 12 also has a left side and a right side of another surface extended outwards to form respectively an arched top wall 126.

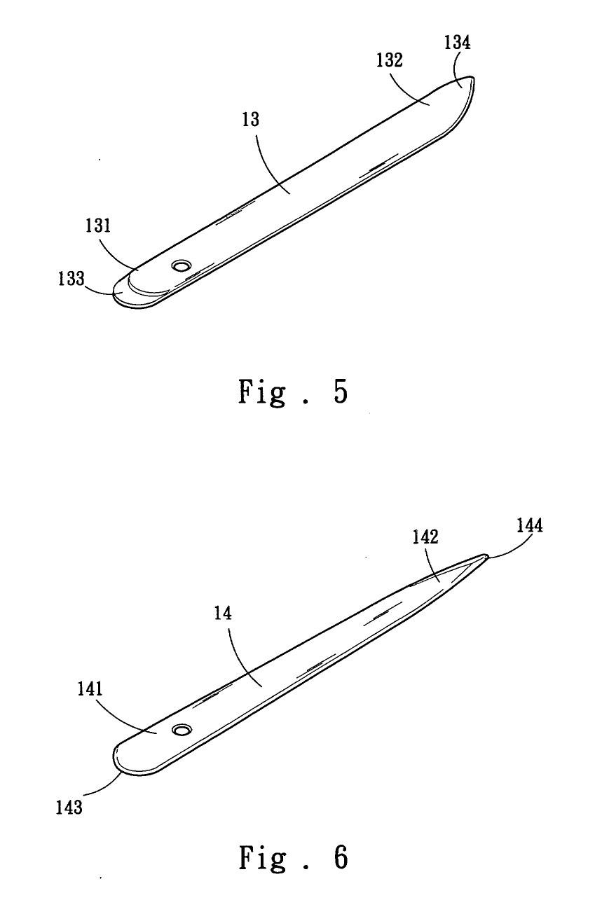

Refer to FIG. 5 for the third type tool 13. It includes a first end 131 and a second end 132. The first end 131 has a distal end formed in a curved first prying portion 133. The second end 132 is extended towards one side and bent at an inclined angle to form a pointed second prying portion 134.

Refer to FIG. 6 for the fourth type tool 14. It includes a first end 141 and a second end 142. The first end 141 is formed in an elliptic shape, and two surfaces of the tool body are shrunk towards one end such that the peripheral edge of the distal end thereof is thinner to become a first prying portion 143. The second end 142 is formed with pointed end at an acute angle to become a second prying portion 144.

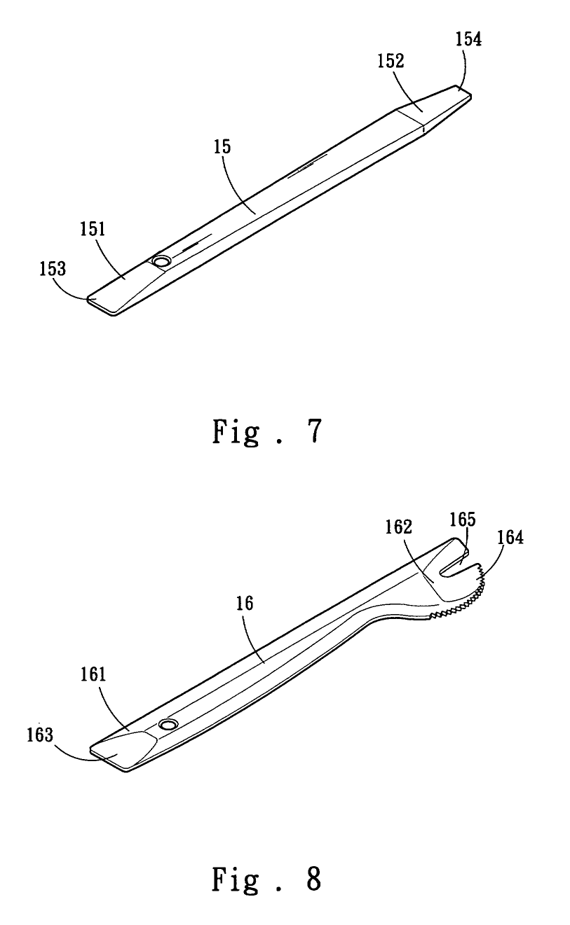

Refer to FIG. 7 for the fifth type tool 15. It includes a first end 151 and a second end 152. The first end 151 is formed substantially in a wedge shape and is extended from one surface of the body of the fifth type tool 15 towards one end in an inclined manner to become a thinner first prying portion 153. The second end 152 is extended from one surface of the body towards another end in an inclined manner to become a wedge-shaped second prying portion 154. The second prying portion 154 has a greater inclined surface length than the first prying portion 153.

Refer to FIG. 8 for the sixth type tool 16. It includes a first end 161 and a second end 162. The sixth type tool 16 has a flat surface on one side and an arched convex surface on another side that gradually becomes thinner from the middle towards the periphery. The first end 161 inclines from the arched convex surface towards one end to become thinner to form a first prying portion 163 with a wedge slant surface. The second end 162 is substantially semi-circular and has a plurality of teeth traces on the periphery, and inclines from the arched convex surface towards another end to become a thinner second prying portion 164. The second prying portion 164 has a third notch 165 in the middle.

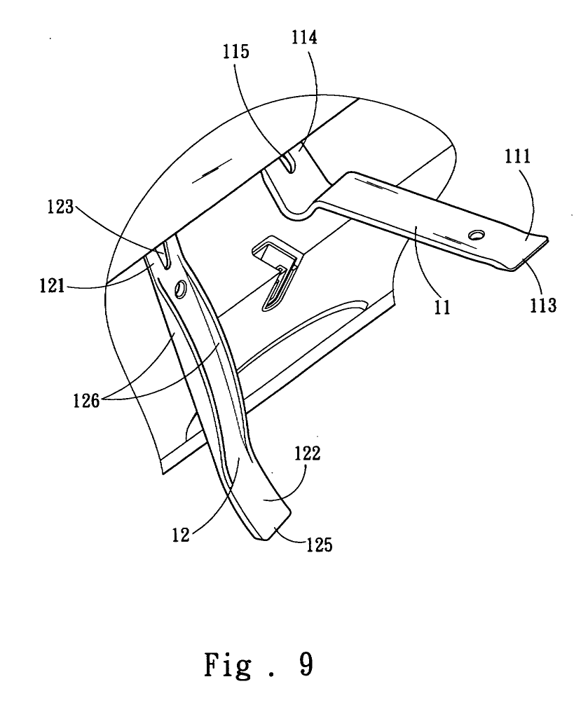

By means of the construction set forth above, referring to FIG. 9, the first type tool 11 and second type tool 12 may be used to pry a plastic case inside the rear trunk of a vehicle. The second prying portion 114 of the first type tool 11 has a bending angle to be inserted into a slit gap on the periphery of the plastic case and can be leaned against a flat surface. Then the first end 111 of the first type tool 11 may be grasped by a user's hand and moved downwards to pry and open the plastic case inside the rear trunk of a vehicle. Next, the first prying portion 124 of the second type tool 12 may be inserted into the slit gap on the periphery of the plastic case, and the second end 122 of the second type tool 12 may be grasped by user's hand and moved downwards to allow the second type tool 12 to be inserted continuously inside the plastic case, and the arched top wall 126 respectively on the right and left side may be used to butt the plastic case, so that the gap becomes larger to allow user's hand to reach the interior thereof to open the plastic case.

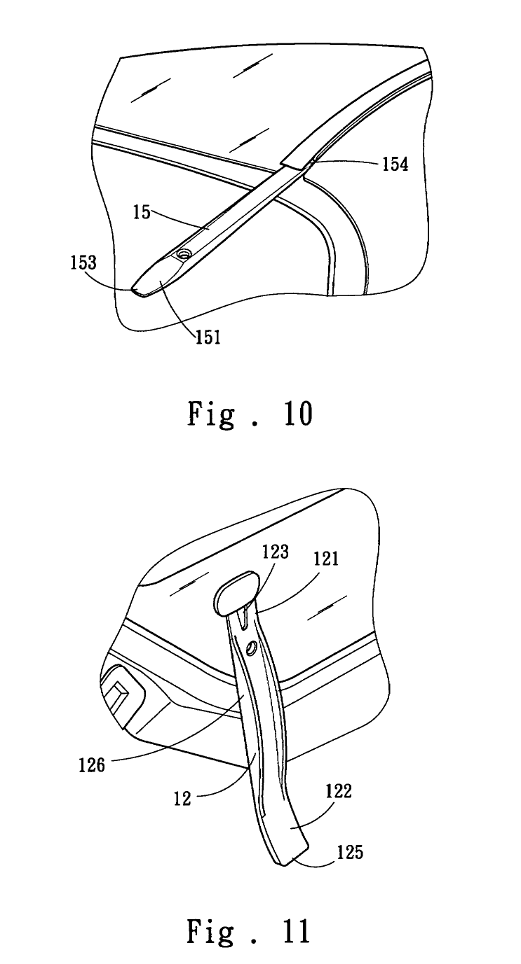

Referring to FIG. 10, the fifth type tool 15 may be used remove a trim on the top panel of vehicles. As the second prying portion 154 of the fifth type tool 15 has a greater length, it can be inserted inside the trim, then the tool may be levered upwards to remove the trim. Moreover, as the fifth type tool 15 is made from hard plastics, it does not damage the paint coating on the surface of the vehicles.

FIG. 11 illustrates another use example in which a latch button of an air bag on the inner side of a car door is pried and removed through the second type tool 12.

When in use, as the decorative plates and trims of vehicles are located on different positions, various types of tools 11, 12, 13, 14, 15 and 16 of the invention of different profiles can be selected to do prying according to requirements. The third and fourth types of tools 13 and 14 may also be used to remove smaller decorative plates and trims (not shown in the drawings). As the first ends 111, 121, 131, 141, 151 and 161 of various types of tools 11, 12, 13, 14, 15 and 16 of the invention have respectively a thinner edge at the distal end to form the first prying portions 113, 124, 133, 143, 153 and 163, they can be easily inserted into the slit gap on the edge of the decorative plates and trims of the vehicles. For smaller decorative plates and trims, the third and fourth types of tools 13 and 14 that have pointed second prying portions 134 and 144 can be easily inserted into the slit gap on the edge of the smaller decorative plates and trims. Moreover, with the second end 112 of the first type tool 11 formed like a hook, it can be leaned against a flat surface to facilitate prying of the plastic case inside the rear trunk of the vehicles.

Prototypes of the invention have been made according to the description previously discussed, and desirable results have been achieved to meet the disclosed object and effect. It provides a significant improvement and a greater practicality over the conventional tool kits.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A tool kit for removing decorative plates and trims of vehicles, comprising a box which holds a plurality of tools of different specifications, the tools being made from hard plastics and formed in a plate shape, and having respectively a first end and a second end, the first end being gradually thinned from a middle portion of a body of the tool towards one end thereof to form a first prying portion at the one end, the second end forming a second prying portion.

2. The tool kit of claim 1, wherein the tools include a first type tool in which the first end has a left side and a right side opposing each other and is extended sidewards in a shield-shape to become the first prying portion, the second end being extended towards one side to form a hook at a desired angle, the second prying portion being formed by extending one surface of the first type tool towards another surface in an inclined manner to become thinner and having a first notch in the center.

3. The tool kit of claim 1, wherein the tools include a second type tool in which the first end has a second notch in the middle thereof to form a fork-like first prying portion, the second prying portion being inclined from one surface towards another surface at a selected angle, the another surface having a left side and a right side that are extended outwards to form respectively an arched top wall.

4. The tool kit of claim 1, wherein the tools include a third type tool in which the first prying portion on the first end is formed in a curve, the second prying portion on the second end being inclined towards one side and bent at a selected angle and formed in a pointed shape.

5. The tool kit of claim 1, wherein the tools include a fourth type tool in which the first end is formed in an elliptic shape, the body of the tool having two surfaces shrinking towards one end such that the peripheral edge of the one end is thinner to form the first prying portion, the second end being formed with a pointed end at an acute angle to become the second prying portion.

6. The tool kit of claim 1, wherein the tools include a fifth type tool in which the first prying portion of the first end and the second prying portion of the second end are formed respectively in a wedge shape, and the body of the tool is inclined from one surface towards two ends to become thinner, the second prying portion having an inclined surface formed at a length greater than that of the first prying portion.

7. The tool kit of claim 1, wherein the tools include a sixth type tool which has a flat surface on one side and an arched convex face on another side that gradually becomes thinner from the middle towards the periphery thereof, the first end being inclined downwards from the arched convex surface towards one end to become thinner to form the first prying portion with a wedge slant surface, the second end being substantially semi-circular and having a plurality of teeth traces on the periphery and being inclined from the arched convex surface towards another end to become thinner to form the second prying portion which has a third notch in the middle.

8. The tool kit of claim 1, wherein the box is made from transparent plastics and has a plurality of anchor troughs inside and is sealed by a back panel on a rear side thereof.
